(19) United States
(12) Patent Application Publication
(10) Pub. No.: US 2005/0158209 A1
(43) Pub. Date: Jul. 21, 2005

(54) Microcomponent connection system

(75) Inventors: Renate Bender, Darmstadt (DE); Gunter Brenner, Griesheim (DE); Thomas Greve, Darmstadt (DE); Matthias Joehnck, Dortmund (DE); Bernd Stanislawski, Frankfurt (DE); Michael Schmelz, Griesheim (DE); Sigrid Sturmfels, Gross-Umstadt (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: Merck Patent GmbH, Darmstadt (DE)

(21) Appl. No.: 10/507,030

(22) PCT Filed: Feb. 10, 2003
(86) PCT No.: PCT/EP03/01285

(30) Foreign Application Priority Data
Mar. 8, 2002 (DE) 102 09 897.2

(51) Int. Cl. B01L 3/00

(52) U.S. Cl. 422/99

(57) ABSTRACT

A microcomponent connection system (1) having an accomodation device for plate-shaped microcomponents (7) has a connection block (2) and a lifting device (6), by means of which the microcomponent (7) and the connection block (2) can be pressed against one another. The connection block (2) has electrical and fluid line connections (8, 9) and optical line connections (16), each of which projects in a sprung or spring-mounted manner on the underside of the connection block (2). In order to connect the microcomponent (7) to the associated line connections (8, 9, 16), the microcomponent (7) is pressed by the lifting device (6) in the direction of the connection block (2) against the electrical line connections (8) or fluid line connections (9) designed as electrically conducting spring tongues or as hollow rams (10), or optical line connections (16).

The invention relates to a microcomponent connection system having an accommodation device for plate-shaped microcomponents and having a plurality of line connections which can be connected to the microcomponent.

In the chemical and pharmaceuticals industry, miniaturised components are increasingly being used for research and production purposes. The development and use of microcomponents enables reactions and analyses to be carried out quickly and effectively with small amounts of substances. This is particularly advantageous if a large number of reactions or analyses are carried out with different substances or under different conditions for research purposes. The use of microreactors also enables the reaction or sample analysis to be carried out in a controlled manner, where parameters such as, for example, the pressure or temperature can be prespecified in significantly greater ranges.

Plate-shaped microcomponents, such as, for example, micromixers or micropumps, are known. These are used for carrying out reactions or analyses with extremely small mass flow rates. Microcomponents of this type usually have a plurality of apertures for the feed and discharge of the substances involved. Electrical heating elements or other power consumers in and on the microcomponent can be supplied with energy and operated via electrical line connections.

Before a reaction or analysis is carried out, the microcomponents used for the reaction must each be connected to all associated line connections. However, the establishment of a leak-proof connection to liquid-carrying line connections is inconvenient and time-consuming, in particular owing to the small dimensions and consequently difficult handling of the line connections and microcomponents involved.

A microcomponent connection system is known (DE 198 54 096 A1) in which a plate-shaped microcomponent is inserted into a carrier rail attached to a connection carrier. Line connections which can be connected to associated connections on an outside of the plate-shaped microcomponent are provided in at least one side wall of the insertion slot of the carrier rail. Although handling of the microcomponents and the associated line connections is significantly simplified through the use of a microcomponent connection system of this type, each individual supply or discharge line for the substances involved in the reaction must nevertheless be connected individually to the carrier rail and the microcomponent inserted therein. Considerable time is needed for this, in particular if the microcomponents are changed frequently.

Every faulty, incompletely leak-proof manual connection of a line connection to the microcomponent inserted in the carrier rail results in participating substances being able to escape during the reaction, but this is very difficult to discover so long as the liquid escaping from the microcomponent does not also escape visibly from the insertion slot of the carrier rail.

WO 00/77511 A1 describes a miniaturised analysis unit for sample preparation. The essentially plate-shaped flow unit having a microstructured channel system has electrical and fluid connections, enabling complex analyses or separations of a sample passed in to be carried out within the miniaturised analysis unit. The illustrative embodiment described is particularly suitable for isotachophoretic separation of a sample.

WO 00/77511 A1 also describes a microcomponent connection system of the generic type mentioned at the outset which is intended for reversible accommodation of a miniaturised analysis unit, the microcomponent. The microcomponent connection system consists of a retention device which holds the flow unit, and a holder, which is arranged above the retention device and which has connection elements for electrical and fluid connecting lines. In order to carry out an analysis, the analysis unit provided must first be introduced into the retention device, and the retention device must subsequently be connected to the holder arranged above it. A reliably leak-proof connection of a fluid connection to the microcomponent can and must only take place after the retention device has been joined to the holder by means of a clamp screw for each associated fluid connection. Owing to the requisite care, this is also time-consuming and labour-intensive.

The object of the invention is accordingly to design a microcomponent connection system in such a way that a microcomponent can be connected quickly and reliably to the associated line connections. It should be possible to produce the microcomponent connection system as simply as possible, and it should enable reliable storage and contacting of the microcomponent.

This object is achieved in accordance with the invention in that the microcomponent and the line connections can be pressed against one another by means of a lifting device. By actuation of the lifting device, the microcomponent is connected to all line connections reliably and at the same time in a leak-proof manner. The pressure of the microcomponent against the line connections can be prespecified by an appropriate lifting device design. Manual connection of the individual line connections to the microcomponent is unnecessary, meaning that a microcomponent can be connected to the associated line connections very quickly and with high reliability.

It is preferably provided that the microcomponent can be pressed against the line connections by means of a lifting device. The microcomponent here can be fixed on the lifting device and pressed against the line connections, which are arranged in a substantially immovable manner, by actuation of the lifting device. This has the result that the individual line connections are permanently arranged and connected to the associated supply equipment. Complex re-contacting of the individual line connections which is required for each individual use is no longer necessary, meaning that, in particular given the achievable miniaturisation of the microcomponents and thus of the line connections, a considerable amount of work is saved and the risk of damage to the individual parts is reduced.

According to an embodiment of the inventive idea, it is proposed that the line connections can be pressed against the microcomponent by means of a lifting device. In this embodiment, the microcomponent is positioned in an immovable holder. By means of the lifting device, the line connections are moved and pressed against the microcomponent. The positioning of the microcomponent in the holder enables, for example, more complex, including with respect to the spatial requirement, and thus more precise temperature control and temperature monitoring of the microcomponent through the holder, compared with the possibilities of temperature control of the microcomponent mounted on a movable lifting device.

According to an advantageous embodiment of the inventive idea, it is proposed that the microcomponent connection system has a connection block with line connections through it, and the microcomponent can be pressed in the direction of the connection block by means of the lifting device. The connection block protects the line connections passed through it against damage, such as, for example, bending of the line connections. A connection block of this type offers sufficient space for the accommodation of electrical and fluid connection devices, to which the microcomponent is connected on actuation of the lifting device. The individual feed or discharge lines can remain permanently connected to the line connections through the connection block, with only the microcomponent being exchanged depending on the reaction to be carried out.

It is preferably provided that the through line connections are in each case arranged in a projecting manner on the underside of the connection block. If the microcomponent is pressed in the direction of the connection block on actuation of the lifting device, the individual line connections each form stops. The pressure of the microcomponent against these stops can be adjusted via the actuation mechanism of the lifting device in such a way that a durable, leak-proof and reliable connection of all line connections to the microcomponent is achieved.

It is also conceivable for the connection block to be a stable, flat, large-area stop against which the microcomponent can be pressed reliably and firmly in a flush manner. The individual line connections are in this case designed in such a way that a leak-proof and reliable connection of the line connections to the microcomponent is ensured as soon as the microcomponent is pressed against the connection block in a flush manner.

It is advantageously provided that the microcomponent accommodated in the accommodation device can be positioned by means of a frame matched to the dimensions of the microcomponent. A leak-proof connection of the line connections located in the connection block to the microcomponent pressed against them can be ensured by simple means only for a certain prespecified position of the microcomponent relative to the line connections and thus to the connection block. This explicit positioning of the microcomponent is achieved with a frame matched to the microcomponent. At the same time, handling of the microcomponent connection system is significantly simplified thereby, and reliable and leak-proof connection to the associated line connections is facilitated, even in the case of frequent changes of the microcomponent.

According to an embodiment of the inventive idea, it is provided that the connection block, the frame and the lifting device form a slot open on one side in which the microcomponent can be accommodated. For accommodation of the microcomponent in the microcomponent connection system and reliable connection of the microcomponent to the associated line connections, the microcomponent need only be introduced completely into the slot open on one side and the lifting device subsequently actuated. In this way, handling of the microcomponent connection system is further simplified and at the same time the microcomponent accommodated in the microcomponent connection system is very substantially protected against external loading and possibly damage.

It is advantageously provided that a coding of the microcomponent connection system (1) enables the alignment of accomodated microcomponents (7) matched thereto to be determined. In this way, an explicit orientation of the microcomponent in the microcomponent connection system can be prespecified and it can thus be ensured that apertures or contact surfaces of the microcomponent are connected to the associated line connections during a reaction or analysis.

It is particularly advantageously provided that the microcomponent has a recess and the frame of the microcomponent connection system has a projection matched to the recess. This forces, by simple means, an explicit orientation of the microcomponent in the microcomponent connection system. Incorrect use during a reaction or analysis is excluded.

It is advantageously provided that the accomodation device has electrical and fluid line connections for connection to the microcomponent. The accomodation device designed in this way has all the line connections usually necessary for carrying out reactions or analyses with microcomponents. There is thus no need for additional, manual connections or further devices. The construction and performance of a complex reaction or analysis with a plurality of microcomponents connected in series, with in each case associated microcomponent connection systems connected to one another, can be carried out quickly. The large number of versatile line connections of the microcomponent connection system enables the conditions and reaction progress in the accommodated microcomponent to be substantially determined and monitored.

It is preferably provided that the fluid line connections have hollow rams and the latter have a concentrically arranged sealing ring around their aperture facing the accommodated microcomponent. The connection of the hollow rams to the associated apertures of the microcomponent is reliably sealed by means of the concentrically arranged, elastic sealing ring. For most applications, a commercially available and therefore inexpensive O-ring can be used for this purpose. The slight non-planarities of the microcomponent surface as a consequence of manufacture can thus reliably be compensated by simple means and a leak-proof connection of the apertures of the microcomponent to the associated hollow rams achieved.

It is particularly advantageously provided that the fluid line connections each have an axially movable, spring-mounted hollow ram. Pressing of the microcomponent against the fluid line connections produces a leak-proof connection between the line connections and the associated apertures of the microcomponent. The line connections in the form of spring-mounted hollow rams may in the process be deflected slightly depending on the spring pressure and the pressure exerted on the microcomponent by the lifting device. This on the one hand ensures continuous and reliable connection between the sprung line connections and the associated apertures of the microcomponent and on the other hand prevents damage to the microcomponents, which are expensive to manufacture, but are often fragile.

According to an advantageous embodiment of the inventive idea, it is provided that the electrical line connections have sprung or spring-mounted electrical contacts. This produces a simple connection of the electrical line connections to associated contact areas on the accommodated microcomponent which provide reliable contacting even during extended operation.

It is preferably provided that the spring-mounted electrical contacts are designed as projecting, electrically conducting, spring-loaded telescope contacts. Electrically conducting telescope contacts of this type can be produced by simple means and thus inexpensively. An electrically conducting connection of the electrical line connections to the associated contact areas of the accommodated microcomponent can be achieved reliably and durably even in the case of frequent removal and re-insertion of the microcomponent. Even for the improbable case that liquid unintentionally escapes from the microcomponent before or during a reaction and cleaning of the microcomponent connection system becomes necessary, the electrical contacts designed as projecting, spring-loaded telescope contacts can easily be cleaned or even exchanged.

According to an advantageous embodiment of the inventive idea, it is proposed that the accomodation device has optical line connections for connection to the microcomponent. In addition to connections for supply of the microcomponent with the substances necessary for carrying out the reaction or measurement and electrical connections, the connection of optical analysis systems is also appropriate for many applications. The term optical line connection here is taken to mean any connection of optical components, waveguides or evaluation systems. Many different measurements for monitoring or evaluation of a reaction can be carried out by means of optical measurement devices which measure the optical properties of the substances and reaction products involved in the reaction and prepare them for further analysis.

An optical line connection here can have substantial design correspondences with a line connection as described above in connection with fluid line connections. Thus, optical line connections can likewise have an axially movable and spring-mounted hollow ram, in the centre of which an optical waveguide is arranged. The hollow ram has a concentrically arranged sealing ring on its aperture facing the microcomponent, which sealing ring also prevents or at least significantly reduces undesired ingress or escape of light into or from the optical line at the junction of the line connections into the microcomponent.

According to an advantageous embodiment of the inventive idea, it is provided that, in addition to the hollow ram or instead of the hollow ram, a cone is located at the end of the line connection facing the microcomponent. A cone of this type simplifies the guiding and positioning of the line connection pressed against the microcomponent in a design of the associated aperture of the microcomponent matched thereto.

It is preferably provided that the cone consists of elastic material. Through the elastic design of the cone at the end of the line connection, the cone is able to produce a tightly sealing connection of the microcomponent to the line connection pressed against it, even without further sealing measures or additional sealing devices.

According to an advantageous embodiment of the inventive idea, it is provided that an optical line connection projects over a channel of the microcomponent on opposite sides. In this way, a plurality of arrangements of one or more waveguides on the line connection are possible, allowing reliable and accurate measurement of various optical properties.

According to an embodiment of the inventive idea, it is provided that a reflection layer is arranged in the region of a channel on the opposite side of an optical line connection. The light emitted by the waveguide of the optical line connection is then reflected by the reflection layer after passing through the channel section and bounced back into the waveguide after passing through the channel section again and can be fed to an evaluation device by means of the same waveguide. This can be a thin reflection layer produced using a known layer application method or alternatively a miniature mirror or the like.

Instead of the reflection layer, it may also be provided that a light source is arranged in the region of a channel on the opposite side of an optical line connection. The waveguide arranged on the channel side opposite the light source transfers the light from the light source passing through the channel section to an evaluation device. The light source can be selected as desired here and can also be changed during a measurement. The intensity of the light source is not limited by the maximum light power of the waveguide, as would be the case if the waveguide were used both for illumination of the channel section and for acquisition of the light to be measured.

It is preferably provided that an optical line connection projects over a channel of the microcomponent on the opposite sides in such a way that an optical signal can be transferred from one side of the optical line connection through the channel to the other side of the optical line connection. In this way, transmitted-light measurements of the reagents and reaction products flowing through the channel can also be carried out in a simple manner.

It is advantageously provided that the lifting device has a support plate for the microcomponent and the temperature of the support plate can be controlled by means of heating and/or cooling devices. This enables the temperature of the microcomponent, which usually lies flush on the support plate, to be influenced in a simple manner during performance of a reaction. It is therefore no longer necessary in many cases to carry out complex temperature control, for example by means of a heating bath surrounding the entire apparatus.

According to an embodiment of the inventive idea, it is provided that additional sensor elements, control elements or pneumatic connections are integrated in the microcomponent connection system. Thus, for example, connections for the optical detection of sample properties in the form of optical fibres for optical analysis systems or controllable outlets for direct connection to a mass spectrometer may be provided in the connection block. Via pneumatic connections, it is possible either for pressure compensation to take place during the feed or reaction of a sample or for the sample to be influenced by controlled excess pressure or reduced pressure.

It is provided that frits or membranes are arranged in the fluid or pneumatic line connections. These enable, for example, chromatographic separations to be carried out in the microcomponent.

According to an embodiment of the inventive idea, it is provided that a plurality of microcomponents can be accommodated simultaneously and in each case connected to associated line connections. It is conceivable here that a plurality of microcomponents are pressed alongside one another on a common lifting device against a common connection block. It is likewise possible and for certain applications advantageous that, in particular in the case of relatively complex reaction processes, a plurality of microcomponents are introduced jointly in a flush manner arranged one above the other into a microcomponent connection system whose dimensions are matched to the dimensions of a microcomponent stack of this type.

It is preferably provided that a plurality of line connections are connected to one another through connecting lines. Both the microcomponent and the microcomponent connection system may have been designed and constructed for versatile, general use, which also enables lower production costs owing to the larger number of units. Through line connections subsequently connected to one another or already connected to one another in a connection block matched thereto, special analysis or reaction processes can be prespecified. Various microcomponent connection systems prepared in this way can be stored in prefabricated form and held ready for use. In this way, various special analysis or reaction processes which are frequently used can be prefabricated from standard components and employed immediately in laboratory operation, thus saving time and costs. Re-equipping and subsequent matching of a prefabricated microcomponent connection system to changed reaction or analysis conditions or further developments is possible at any time.

According to an embodiment of the inventive idea, the use of a microcomponent connection system for carrying out microfluid-controlled chemical reactions is proposed. Thus, syntheses or analyses of this type can be carried out quickly and reliably. Only extremely small amounts of the sample material are consumed for the synthesis or analysis. The dead space in the microcomponent and in the connection lines can be minimised, thus substantially reducing unnecessary losses of sample material.

Particularly advantageous is the use of a microcomponent connection system for carrying out polymerase chain reactions (PCR reactions), electrophoretic separations or electrochromatographic analyses in samples. The microcomponent connected to the microcomponent connection system forms a closed system during the reaction or analysis. The reaction or analysis therefore cannot be impaired by impurities or reaction conditions which can only be determined inadequately, for example undetectable changes in amount. The microcomponent can be designed as a disposable article to be used only once, enabling the greatest possible purity to be achieved during the reaction or analysis. In this way, in particular, biochemical or diagnostic processes can be carried out with high precision. In addition, additional advantages arise on use of the microcomponent connection system with a microcomponent as a closed system, such as, for example, suppression of electro-osmotic flow, enabling electrochromatography to be carried out with improved accuracy.

Further embodiments of the inventive idea are the subject-matter of further sub-claims.

An illustrative embodiment is explained in greater detail below and is shown in the drawing, in which:

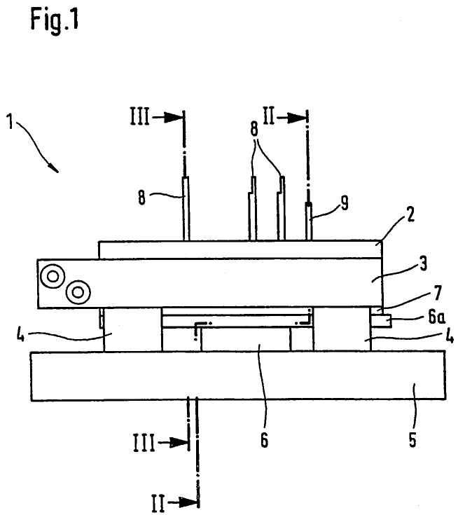

FIG. 1 shows a side view of a microcomponent connection system,

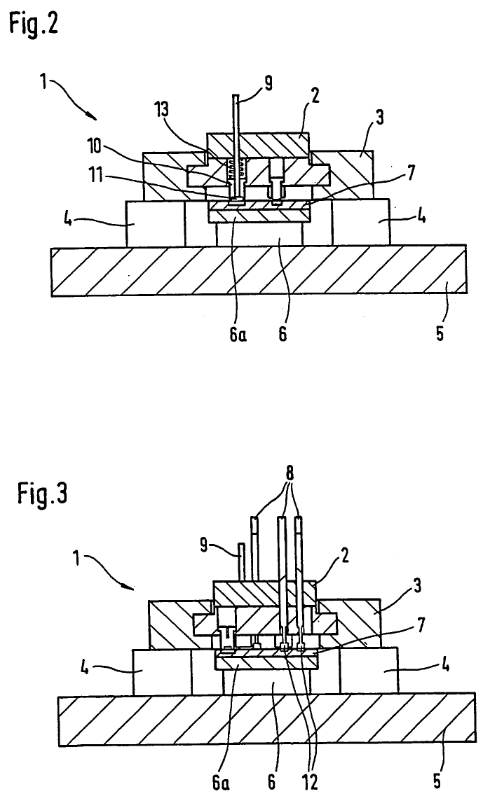

FIG. 2 shows a section along line II-II of the microcomponent connection system depicted in FIG. 1,

FIG. 3 shows a section along line III-III of the microcomponent connection system depicted in FIG. 1,

FIG. 4 shows an inclined plan view of the microcomponent connection system,

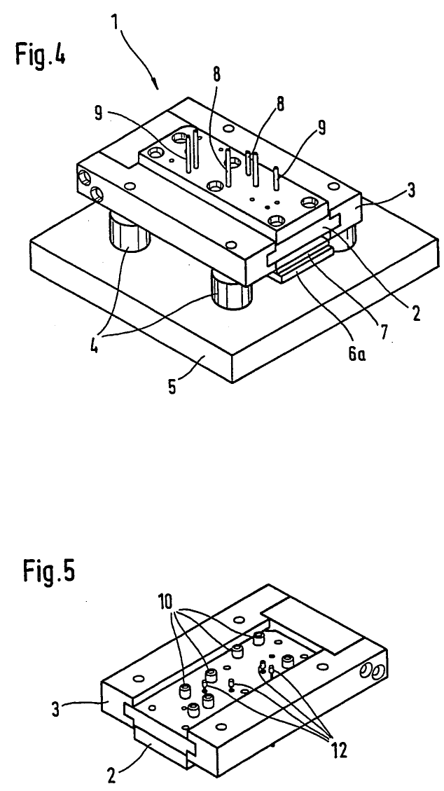

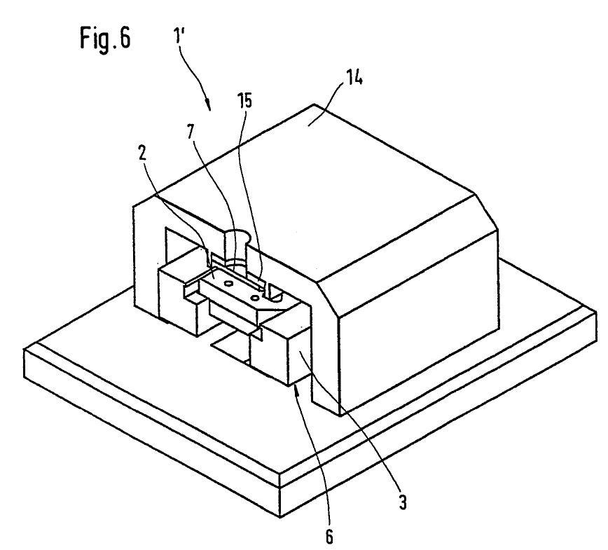

FIG. 5 shows a view of the underside of the microcomponent connection system shown in FIG. 1, depicted for better understanding without base plate and spacer,

FIG. 6 shows a side view of a microcomponent connection system of different design in partial cutaway view,

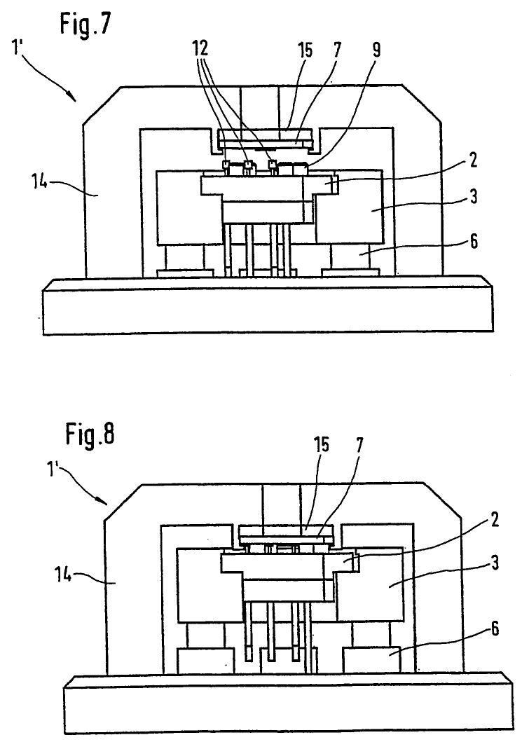

FIG. 7 shows a section along line VII-VII of the microcomponent connection system depicted in FIG. 6 with the lifting device lowered,

FIG. 8 shows a section along line VII-VII of the microcomponent connection system depicted in FIG. 6 with the lifting device raised,

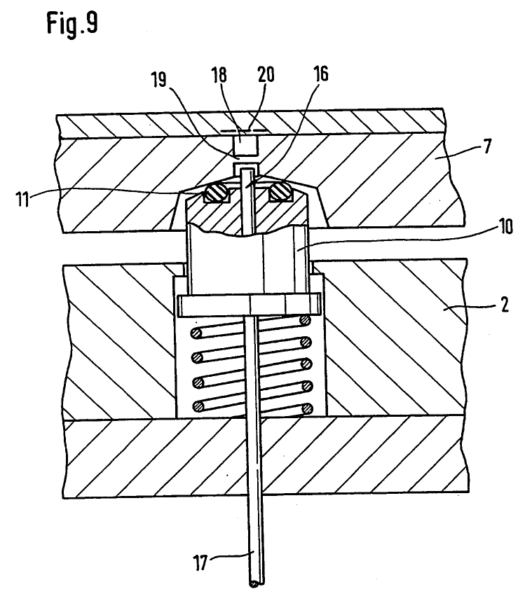

FIG. 9 shows a section through a region of a microcomponent connection system with an optical line connection,

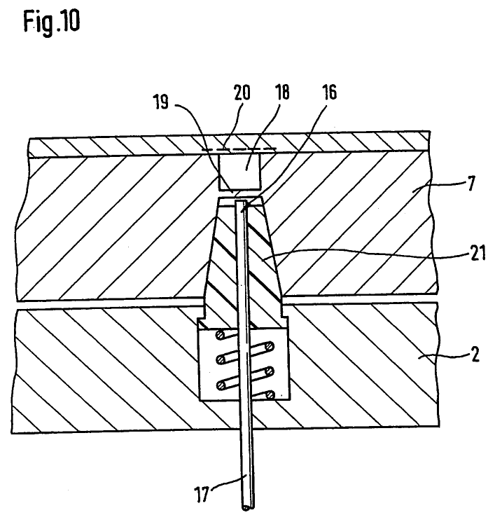

FIG. 10 shows a section through a region of a microcomponent connection system with an optical line connection of different design,

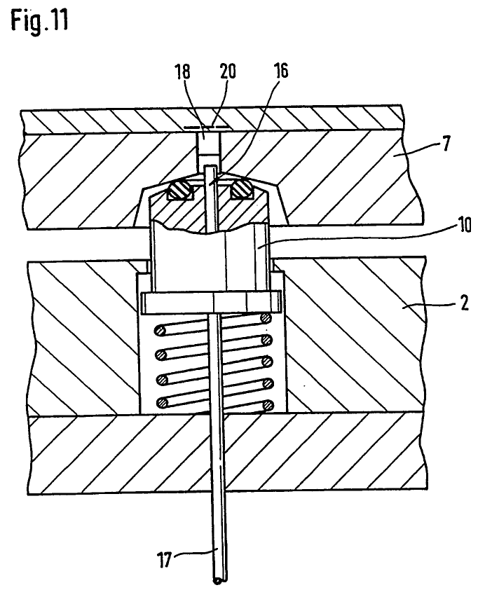

FIG. 11 shows a section through a region of a microcomponent connection system with an optical line connection of further different design,

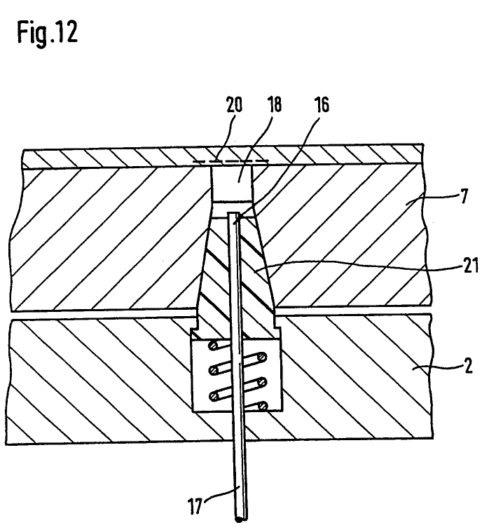

FIG. 12 shows a section through a region of a microcomponent connection system with an optical line connection of still different design,

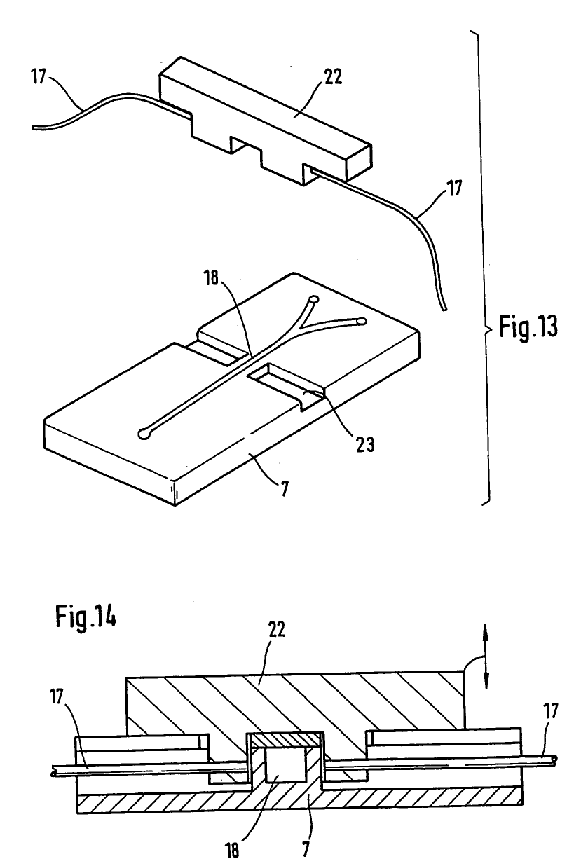

FIG. 13 shows a view of a microcomponent with an associated optical line connection,

FIG. 14 shows a section through the microcomponent depicted in FIG. 13 with the optical line connection connected thereto,

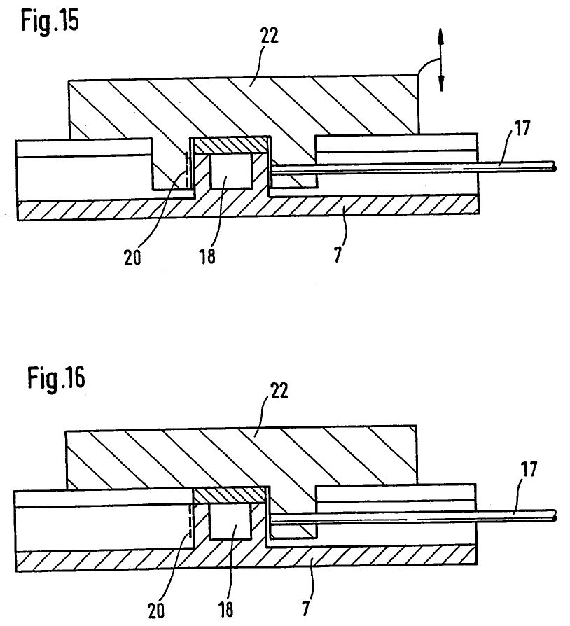

FIG. 15 shows a section through the microcomponent depicted in FIG. 13 with an optical line connection of different design connected thereto, and

FIG. 16 shows a section through a microcomponent with an optical line connection connected thereto.

A microcomponent connection system 1 depicted in FIGS. 1 to 5 has a connection block 2, which is surrounded on its two side faces and its back by a frame 3 which is connected to the connection block 2 in a positive manner. The connection block 2 with the frame 3 partially surrounding it is mounted on a base plate 5 via spacers 4.

A lifting device 6 is arranged beneath the connection block 2. The lifting device 6 can have, for example, a cam, spindle or knee-lever mechanism. This results in a robust, manually actuatable lifting device 6. It is also conceivable for the lifting device 6 to be actuatable by means of a controllable pneumatic cylinder, an electrically driven scissor jack or an electric spindle drive. A design of this type enables automated actuation of the lifting device 6, which is particularly advantageous when carrying out a large number of reactions, such as, for example, in research or industrial production.

The lifting device 6 has a support plate 6a, which supports a microcomponent 7. The microcomponent 7 is pressed in the direction of the connection block 2 by the lifting device 6. An opposite movement of the lifting device 6 enables the microcomponent 7 to be lowered and then easily removed. The frame 3 forms lateral stops on the underside of the connection block 2, which predetermine with sufficient accuracy the position of a microcomponent 7 pressed in the direction of the connection block 2.

The connection block 2 is connected to electrical line connections 8 and fluid line connections 9. The fluid line connections 9 each run into a hollow ram 10 which is mounted so as to be axially movable. The fluid line connections 9 are arranged in such a way that the hollow ram 10 is arranged directly above an associated aperture of the microcomponent 7 and, when the microcomponent 7 is pressed in the direction of the connection block 2, forms a through-connection of the fluid line connection 9 to the associated aperture in the microcomponent 7. FIG. 2 shows that the transition from the hollow ram 10 to the aperture of the microcomponent 7 is reliably sealed by means of a sealing ring 11, in the example shown an O-ring, arranged concentrically on the hollow ram 10.

The electrical line connections 8 are, as shown in FIG. 3, connected to electrical spring-mounted telescope contacts 12, which are designed as projecting electrically conducting spring tongues. The electrical telescope contacts 12 are arranged here in such a way that an electrically conducting contact with associated contact areas of the microcomponent 7 is reached as soon as the latter is pressed in the direction of the connection block 2 by means of the lifting device 6.

The spring force of the electrical telescope contacts 12 designed so as to be projecting and of the helical spring 13 which is responsible for the spring-mounting of the hollow ram 10 is set in such a way that firstly reliable, electrically conducting or tightly sealing contact is ensured between the line connections 8, 9 and the associated contact areas or apertures of the microcomponent 7, and on the other hand damage to the microcomponent 7 due to excessive loading or excessive pressure is excluded.

In order to exchange the microcomponent 7, the lifting device 6 merely need be moved downwards and the microcomponent 7 thus moved away from the associated line connections 8, 9 and thus freed. The microcomponent 7 can then be removed simply and replaced by another microcomponent. As soon as this newly introduced microcomponent is pressed against the line connections 8, 9 by means of the lifting device 6, the microcomponent connection system 1 with the new microcomponent is ready for use.

It is conceivable that the temperature of the support plate 6a can be controlled or regulated by means of, for example, electrically operated heating and/or cooling devices. In this way, the temperature of the microcomponent lying on the support plate 6a can be influenced or prespecified during a reaction by simple means.

In the view of the underside of the connection block 2 which is shown in FIG. 5, it is clear that the hollow ram 10 and the spring-loaded telescope contacts 12 each project. If the microcomponent 7, not shown, is pressed in the direction of the connection block 2, leak-proof or electrically conducting connections of the microcomponent 7 to the respectively associated hollow rams 10 or telescope contacts 12 arranged in a sprung manner are made.

In the microcomponent connection system 1′ depicted in FIGS. 6 to 8, a bridge-shaped microcomponent holder 14 is arranged above the lifting device 6. The microcomponent 7 can be positioned in an immovable manner in an insertion slot 15 on the inside of the microcomponent holder 14 facing the upper side of the lifting device 6 in such a way that the apertures of the microcomponents are facing the lifting device 6. After the microcomponent 7 has been positioned in the microcomponent holder 14, the connection block 2 containing the line connections 8, 9 can be moved towards the microcomponent 7 by means of the lifting device 6 so that the line connections 8, 9 are pressed against the microcomponent 7 and establish contact with the associated apertures of the microcomponent. In the region of the microcomponent 7, the microcomponent holder 14 can additionally have a device, not shown, for regulated temperature control of the microcomponent 7.

Suitable materials for the microcomponent connection system are in principle all industrial materials. If high chemical resistance is required, depending on the application, chemically resistant materials, such as, for example, polyaryl ether ketones (PEEK) and polytetrafluoroethylene (PTFE), can be used for the line connections, and perfluorinated elastomers can be used for the sealing elements. It is furthermore possible to use microcomponents in which part-regions of the microcomponent or the entire microcomponent consist of transparent material, for example of glass. This gives rise to further possibilities for the use of the microcomponent connection system also in combination with optical analysis systems.

FIGS. 9 to 16 show optical line connections 16 of various design, each of which has an optical waveguide 17, for example a glass fibreoptic.

In the optical line connection depicted in FIG. 9, the waveguide 17 is located in the interior of a hollow ram 10, which is mounted so as to be axially movable and which is pressed in the direction of the microcomponent 7 by means of a spring. As likewise in the preceding illustrative embodiment of a hollow ram, the transition from the hollow ram 10 to the aperture of the microcomponent 7 is reliably sealed by means of a sealing ring 11, in the example depicted an O-ring, which is arranged concentrically on the hollow ram 10. The aperture of the waveguide associated with the optical line connection 16 is arranged directly in a channel section 16 of the microcomponent 7 in such a way that the waveguide 17 of the line connection 16 pressed against the microcomponent 7 points directly at the channel section 18 and is separated therefrom only by a window 19. A reflection layer 20 is located on the side of the channel section 18 opposite the waveguide 17. In this way, the channel section 18 can be illuminated and the light entering the waveguide 17 again after passing through the channel section 18 twice can be used for evaluation and analysis.

In the optical line connection 16 depicted in FIG. 10, a cone 21 of elastic material is used instead of the rigid hollow ram with additional sealing ring 11. The elastic cone 21, given a design of the associated aperture of the microcomponent 7 matched thereto, results in simple and reliable positioning and sealing of the optical line connection 16.

FIGS. 11 and 12 show the optical line connections depicted in FIGS. 9 and 10 in modified embodiments in each case. In both cases, no window 19 is arranged between the channel section 18 and the waveguide 17, so that exit of the medium flowing through the channel section 18 is only prevented in the case of an optical line connection 16 in close contact. Embodiments of this type can in certain cases facilitate better and more accurate measurement results since direct optical analysis of the medium flowing through the channel section 18 can take place.

FIGS. 13 to 16 depict various optical line connections 16 which project over the channel section 18, at least on one side. The line connections 16 here have a connecting element 22 which bridges the channel section 18 and in which in each case a waveguide 17 extending as far as the channel section 18 is arranged on one side or on both sides of the channel section 18. In this way, as depicted, for example, in FIG. 14, optical transparency measurement of the medium flowing through the channel section 18 can be carried out. Also possible in accordance with FIGS. 15 and 16 are designs in which a reflection layer 20 arranged either on the connecting element 22 or even on the microcomponent 7 reflects the light exiting from the waveguide 17 after a first passage through the channel section 18 and throws it back into the waveguide 17 again after a second passage through the channel section 18. In the region of the channel section 18 used for the measurements, the microcomponent 7 has recesses 23 for the introduction of the optical line connection on both sides of the channel section 18.

1. Microcomponent connection system having an accomodation device for plate-shaped microcomponents and having a plurality of line connections which can be connected to the microcomponent, characterised in that the microcomponent (7) and the line connections (8, 9, 16) can be pressed against one another by means of a lifting device (6).

2. Microcomponent connection system according to claim 1, characterised in that the microcomponent (7) can be pressed against the line connections (8, 9, 16) by means of a lifting device (6).

3. Microcomponent connection system according to claim 1, characterised in that the line connections (8, 9, 16) can be pressed against the microcomponent (7) by means of a lifting device (6).

4. Microcomponent connection system according to claim 1, characterised in that the lifting device (6) can be actuated manually by means of a cam, spindle or knee-lever mechanism.

5. Microcomponent connection system according to claim 1, characterised in that the lifting device (6) can be actuated by means of a controllable pneumatic cylinder, an electrically driven scissor jack or an electric spindle drive.

6. Microcomponent connection system according to claim 1, characterised in that the microcomponent connection system (1) has a connection block (2) with line connections (8, 9, 16) passed through, and the microcomponent (7) can be pressed in the direction of the connection block (2) by means of the lifting device (6).

7. Microcomponent connection system according to claim 4, characterised in that the microcomponent (7) accommodated in the accomodation device can be positioned by means of a frame (3) matched to the dimensions of the microcomponent (7).

8. Microcomponent connection system according to claim 5, characterised in that the connection block (2), the frame (3) and the lifting device (6) form a slot open on one side in which the microcomponent (7) can be accommodated.

9. Microcomponent connection system according to claim 1, characterised in that a coding of the microcomponent connection system (1) enables the alignment of accomodated microcomponents (7) matched thereto to be determined.

10. Microcomponent connection system according to claim 7, characterised in that the microcomponent (7) has a recess, and the frame (3) of the microcomponent connection system (1) has a projection matched to the recess.

11. Microcomponent connection system according to claim 1, characterised in that the accomodation device has electrical and fluid line connections (8, 9) for connection to the microcomponent (7).

12. Microcomponent connection system according to claim 1, characterised in that the fluid line connections (9) each have a hollow ram (10).

13. Microcomponent connection system according to claim 10, characterised in that the hollow ram (10) has a concentrically arranged sealing ring (11) around its aperture facing the accommodated microcomponent (7).

14. Microcomponent connection system according to claim 10, characterised in that the hollow ram (10) is axially movable and spring-mounted.

15. Microcomponent connection system according to claim 1, characterised in that the electrical line connections (8) have sprung electrical contacts (12).

16. Microcomponent connection system according to claim 1, characterised in that the electrical line connections (8) have spring-mounted electrical contacts (12).

17. Microcomponent connection system according to claim 14, characterised in that the spring-mounted electrical contacts (12) are designed as projecting, electrically conducting, spring-loaded telescope contacts.

18. Microcomponent connection system according to claim 1, characterised in that the accomodation device has optical line connections (16) for connection to the microcomponent (7).

19. Microcomponent connection system according to claim 18, characterised in that the optical line connections (16) each have a hollow ram (10).

20. Microcomponent connection system according to claim 18, characterised in that the hollow ram (10) has a concentrically arranged sealing ring (11) around its aperture facing the accommodated microcomponent (7).

21. Microcomponent connection system according to claim 1, characterised in that the hollow ram (10) is axially movable and spring-mounted.

22. Microcomponent connection system according to claim 1, characterised in that the hollow ram (10) has a cone (21) at its end facing the accommodated microcomponent (7).

23. Microcomponent connection system according to claim 22, characterised in that the hollow ram (10) has a cone (21) of elastic material.

24. Microcomponent connection system according to claim 18, characterised in that an optical line connection (16) projects over a channel section (18) of the microcomponent (7) on opposite sides.

25. Microcomponent connection system according to claim 18, characterised in that a reflection layer (20) is arranged in the region of a channel section (18) on the opposite side of an optical line connection (16).

26. Microcomponent connection system according to claim 18, characterised in that a light source is arranged in the region of a channel section (18) on the opposite side of an optical line connection (16).

27. Microcomponent connection system according to claim 18, characterised in that an optical line connection (16) projects over a channel section (18) of the microcomponent (7) on opposite sides in such a way that an optical signal can be transferred from one side of the optical line connection (16) through the channel section (18) to the other side of the optical line connection (16).

28. Microcomponent connection system according to claim 1, characterised in that the lifting device (6) has a support plate (6a) for the microcomponent, and the temperature of the support plate (6a) can be controlled by means of heating and/or cooling devices.

29. Microcomponent connection system according to claim 1, characterised in that additional sensor elements, control elements or pneumatic line connections are integrated in the microcomponent connection system (1).

30. Microcomponent connection system according to claim 1, characterised in that frits or membranes are arranged in the fluid (9) and/or pneumatic line connections.

31. Microcomponent connection system according to claim 1, characterised in that a plurality of microcomponents (7) can be accommodated simultaneously and can each be connected in parallel or series to associated line connections (8, 9, 16).

32. Microcomponent connection system according to claim 1, characterised in that a plurality of line connections (8, 9, 16) are connected to one another through connecting lines.

33. Use of a microcomponent connection system according to claim 1 for carrying out microfluid-controlled chemical reactions.

34. Use of a microcomponent connection system according to claim 1 for carrying out electrophoretic separations and analyses of samples.

35. Use of a microcomponent connection system according to claim 1 for carrying out isotachophoretic separations and analyses of samples.

36. Use of a microcomponent connection system according to claim 1 for carrying out polymerase chain reactions (PCR reactions) in samples.

37. Use of a microcomponent connection system according to claim 1 for the distribution of sample material over a plurality of microcomponents.

38. Use of a microcomponent connection system according to claim 1 for the collection of separated fractions of sample material after a chromatographic separation.
